(19) United States
(12) Patent Application Publication
(10) Pub. No.: US 2023/0332907 A1
(43) Pub. Date: Oct. 19, 2023

(54) METHOD AND SYSTEM OF EVALUATION OF NAVIGATION SAFETY

(71) Applicant: The Texas A&M University System, College Station, TX (US)

(72) Inventors: Soheil Sohrabi, Dallas, TX (US); Dominique Lord, College Station, TX (US)

(21) Appl. No.: 18/120,527

(22) Filed: Mar. 13, 2023

Related U.S. Application Data
(60) Provisional application No. 63/319,770, filed on Mar. 15, 2022.

(51) Int. Cl. G01C 21/34

(52) U.S. Cl. CPC G01C 21/3461; G01C 21/3492

(57) ABSTRACT

A method of determining route safety includes receiving trip information from a user. The trip information includes an origin and a destination. Route alternatives are identified and, for each route alternative, a road network is divided into a plurality of homogenous road segments. Crash data is assigned to each road segment of the plurality of homogeneous road segments. Crash risk is accumulated for each route of the route alternatives. A route with a lowest crash risk is reported to a user.

### CROSS-REFERENCE TO RELATED APPLICATIONS

This patent application claims priority from, and incorporates by reference the entire disclosure of, U.S. Provisional Application No. 63/319770 filed on Mar. 15, 2022.

### TECHNICAL FIELD

The present disclosure relates generally to automotive navigation systems and more particularly, but not by way of limitation, to methods and systems for determining a safest vehicular route.

### BACKGROUND

This section provides background information to facilitate a better understanding of the various aspects of the disclosure. It should be understood that the statements in this section of this document are to be read in this light, and not as admissions of prior art.

Automotive navigation systems—also referred to as route guidance systems (RGSs)-are driving assistance technologies and have been part of the intelligent transportation system (ITS) for many years. RGSs, which rely on the Global Positioning System (GPS), were initially introduced as in-vehicle technology—either built-in or nomadic devices— and are now widely used in the form of smartphone applications, commonly known as “apps.” The RGS application has evolved since its beginnings, from providing drivers with turn-by-turn route information to finding the shortest route between sets of origins and destinations (mainly the route with minimum travel time). Thus, the benefit of using RGS is not limited to guiding drivers who are unfamiliar with their routes: it also helps to minimize travel times, alleviate traffic congestion, and reduce energy consumption and air pollutant emissions.

As would be expected from driving assistance systems, RGSs are shown to have the potential to improve traffic safety. Despite the numerous safety advantages of RGSs, mainly through the turn-by-turn guidance it provides for drivers who are unfamiliar with routes, there are unintended negative consequences of using RGS. Among the safety impacts of RGSs, it is known that the potential distractions that can hinder drivers’ reaction times, riskier lane-changing behavior, and degradation in the performance of older drivers while using RGS. Nevertheless, the negative impacts of RGSs are not limited to these concerns only. As RGSs aim to find the shortest path between a beginning and an end point, they can, therefore, misguide drivers, such that they take routes which may minimize travel time but, concurrently, carry a greater risk of crashes. In urban areas, RGSs can guide drivers onto roads that have higher crash risks, given the higher number of traffic interruptions and conflicts, higher chances of exceeding speed limits, and poorer geometric designs associated with these thoroughfares. In rural areas, navigating road users through the routes with lower functional classes (rural local and rural collectors)—which are associated with a higher risk of crashes because of poor geometric designs (e.g., median presence and shoulder width), drainage problems, lack of illumination, wildlife crossings, and higher levels of traffic disruption-is another example of RGS misguidance.

### SUMMARY

This summary is provided to introduce a selection of concepts that are further described below in the Detailed Description. This summary is not intended to identify key or essential features of the claimed subject matter, nor is it to be used as an aid in limiting the scope of the claimed subject matter.

Aspects of the disclosure relate to a method of determining route safety. The method includes receiving trip information from a user. The trip information includes an origin and a destination. Route alternatives are identified and, for each route alternative, a road network is divided into a plurality of homogenous road segments. Crash data is assigned to each road segment of the plurality of homogeneous road segments. Crash risk is accumulated for each route of the route alternatives. A route with a lowest crash risk is identified and reported to a user.

Aspects of the disclosure relate to a computer-program product comprising a non-transitory computer-usable medium having computer-readable program code embodied therein. The computer-readable program code adapted to be executed to implement a method. The method includes receiving trip information from a user. The trip information includes an origin and a destination. Route alternatives are identified and, for each route alternative, a road network is divided into a plurality of homogenous road segments. Crash data is assigned to each road segment of the plurality of homogeneous road segments. Crash risk is accumulated for each route of the route alternatives. A route with a lowest crash risk is identified and reported to a user.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a diagram of an observed road network according to aspects of the disclosure;

FIG. 2 is a flow diagram illustrating a method for comparison of route distance and safety according to aspects of the disclosure;

FIG. 3 is a table illustrating road segment functional classifications according to aspects of the disclosure;

FIGS. 4A-4C are graphs illustrating explanatory analyses of crash data from and showing the role of adverse weather conditions in increasing the rate of crashes according to aspects of the disclosure;

FIG. 5 is a table illustrating three arbitrary negative binomial cumulative distribution functions (CDF) of crash probability;

FIG. 6 is a schematic diagram of routes between origins and destinations according to aspects of the disclosure;

FIG. 7 is a table illustrating a distribution of prediction errors according to aspects of the disclosure;

FIG. 8 is a schematic diagram of a route-finding architecture according to aspects of the disclosure; and

FIG. 9 is a schematic diagram of a route guidance system according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Examinations of the safety of the shortest route suggested by road navigation apps in a rural area raised the consideration of safety in RGSs. Aspects of the disclosure relate to a system architecture that incorporates safety in the RGS. In various embodiments, attention was focused on rural areas with (1) higher fatalities per vehicle miles traveled (VMT) compared to urban areas, (2) higher rates of drivers who are unfamiliar with the routes and a concomitant bolder role of RGS, and (3) less variation in traffic condition and mainly with free-flow condition. Aspects of the disclosure relate to a methodology for quantifying the risk of crashes for each route (based on the long-term mean of the expected crashes for each segment along the route). To this end, road safety is defined based on the theoretical probability of crashes as a function of weather and traffic conditions, as well as road characteristics and geometry. Presented herein is a route-finding architecture for both static and dynamic RGSs that seek the route with the lowest risk of crashes. The requirements of and barriers to developing a Safety Route Guidance System (S-RGS) are further discussed. A goal of the systems and methods herein is aimed at attracting the attention of those developing road navigation systems as well as researchers and practitioners involved in traffic safety. The proposed system architecture could also stimulate dialogue about vehicle routing in smart cities and the routing of connected and autonomous vehicles.

### Shortest Route vs. Safest Route

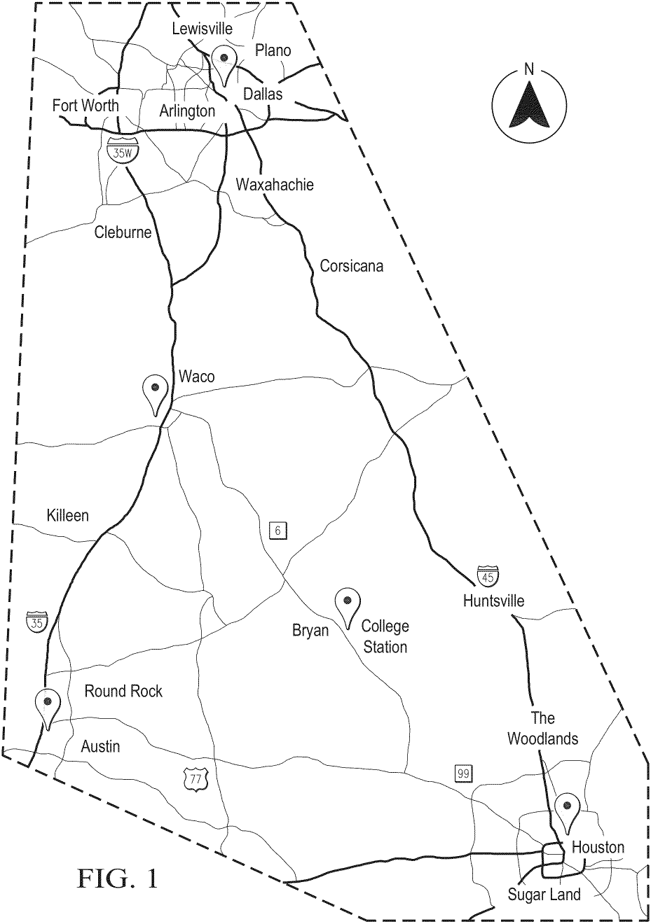

FIG. 1 is a diagram of an observed road network. Aspects of the disclosure focus on road network connecting five metropolitan areas in Texas, US-Dallas-Fort Worth (DFW), Waco, Austin, Houston, and Bryan-College Station (BCS)—with a population higher than 100,000. The rationale behind selecting this area was threefold. First, a spectrum of road functional classes (minor arterials to fully controlled-access arterials or interstates) can be found in the area. Second, a wide range of variety in travel times between origins and destinations (1 hour to 4 hours) is covered that helps with the generalization of the results. Third, the studied road network passes through the area with low population and urbanization density and, therefore, with lower unobservable contributing factors to the risk of crashes, such as land-use impacts.

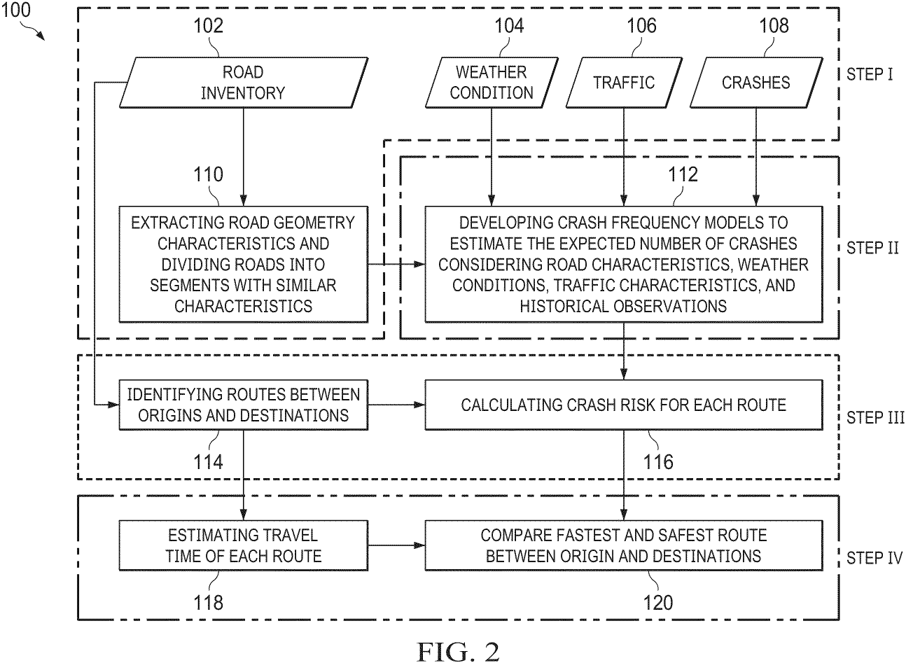

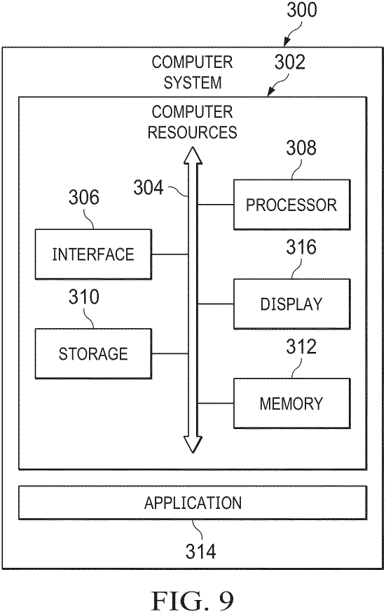

FIG. 2 is a flow diagram illustrating a method 100 for comparison of route distance and safety according to aspects of the disclosure. Method 100 may be carried out by a computer system that is either portable or integrated into an automobile. For example, the computer system may be an S-RGS system 300 (see FIG. 9 and related discussion). In Step I, datasets, including road inventory 102, weather conditions 104, traffic characteristics 106, and historical crash data 108 are collected and combined. Road inventory 102 includes an identification of the roads in a geographic area of interest. Step I also includes a processing step 110 that includes dividing roads from road inventory 102 into homogeneous road segments. In Step II, crash-frequency prediction models 112 are developed to estimate the expected value of crashes at the homogenous road segments. In Step III, routes 114 between origins and destinations are identified and a risk analysis 116 that determines a risk of crashes is performed for each homogenous road segment and accumulated for each route. In Step IV, an estimate 118 of travel time for each route is performed and a safety analysis 120 is performed to compare the safest and shortest routes. Steps I-IV are discussed in more detail below.

### Step I: Collecting Data

### Road and Traffic Data

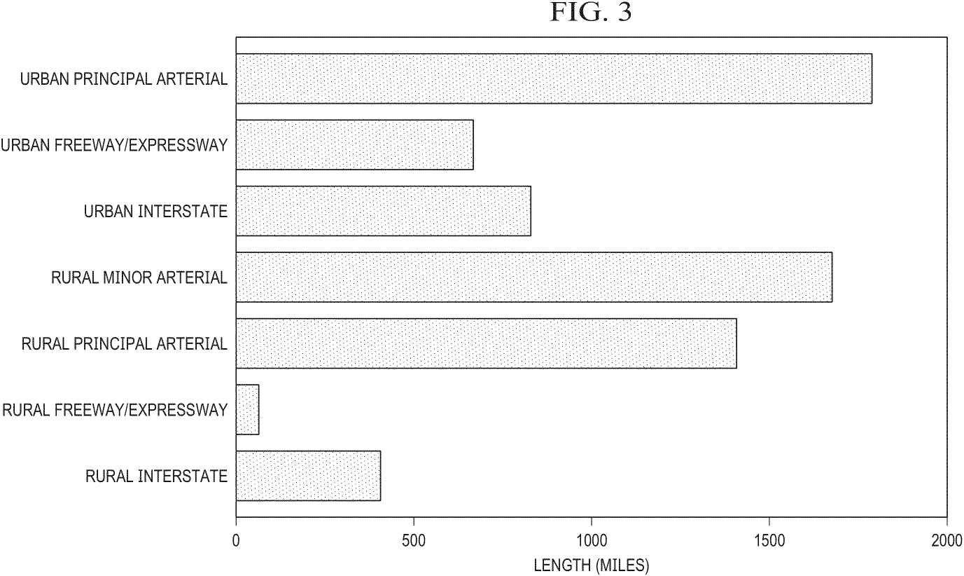

Road inventory 102 data were extracted from a database (e.g., the Texas Department of Transportation (TxDOT) roadway inventory system). The roadway inventory data contain roadway characteristics, includes road geometry design characteristics, road cross-section characteristics (e.g., number of lanes, lane width, shoulder width, and median), road structures, illumination, road functional classifications and averaged daily traffic (ADT). The yearly vehicle-mile traveled (VMT) in each road segment was further estimated as a product of road segment length in miles and ADT. The studied road network consists of both urban and rural road segments with four rural functional classes including interstate, freeway/expressway, principal arterial and minor arterial, and three urban functional classes including interstate, freeway/expressway, and principal arterial. FIG. 3 is a table illustrating road segment functional classifications and lengths according to aspects of the disclosure

### Road Segmentation

Since the basis of the analysis is at the road segment level, homogeneous road segments in terms of geometry, cross-section characteristics, and illumination were defined. Given the limitations in the existing road characteristics data, various embodiments may be used, for example the Road Curvature Analyst (ROCA) tool for extracting the road curvatures and its characteristics. This geographical information system (GIS) based tool identifies the horizontal curves and tangents using machine learning techniques and computes the horizontal curve radii and the azimuth of tangents. Processing step 110 divides roads into segments with homogeneous characteristics, including road alignment, number of lanes, median type and width, shoulders type and width, lighting, and lane width.

### Weather Data

Weather conditions 104 includes rainfall, hail, and snow events, which were collected from a database (e.g., the Iowa Environment Mesonet, which archives automated airport weather observations). Weather conditions 104 data is collected and assigned to the closest road segments generated in processing step 110, based on the Euclidean distance.

Weather conditions 104 are classified into two groups, adverse weather conditions and clear weather conditions. The adverse weather condition represents fog, hail, rain, and snow events, while the clear weather condition group includes clear and cloudy weather with no participation. For each road segment, the total number of hours with adverse and clear weather conditions were calculated.

### Crash Data

Historical crash data 108 is collected from a database (e.g., the TxDOT Crash Report Information System (aka CRIS)). Given the fact that crashes are rare events and vary from year to year, crash data from multiple years (e.g., the last three years) can be used to consider the fluctuations in the number of crashes in years. The crash data may include the time-of-crash, exact coordinates of the crash scene, and whether the crashes happened at, or are related to, an intersection.

Historical crash data 108 associated with road segments was combined with weather conditions 104. The dataset consists of yearly crash frequencies for 2015 to 2017, road segment alignment and cross-section characteristics, and ADT. The traffic volume was approximated in various weather conditions using the number of hours of adverse and clear weather conditions in a year, assuming a uniform distribution of hourly traffic flow in a day. After cleaning the dataset for missing values, a total number of 29,382 road segments were included in the dataset. A summary of statistics and distribution of continuous and categorical data are reported in Tables 1 and 2, respectively.

TABLE 1

Summary statistics of continuous variables

| Variable | Mean | SD | Minimum | Maximum |
|---|---|---|---|---|
| Curve radius (feet) | 496.8 | 246.8 | 43.3 | 2003.9 |
| Median width (feet) | 19.2 | 37.2 | 0.0 | 500.0 |
| ADT (vehicle/day) | 34021.2 | 44733.0 | 360.0 | 329766.0 |
| Truck Percentage | 10.6 | 8.4 | 0.7 | 63.5 |
| Lane width (feet) | 12.3 | 1.4 | 8.0 | 25.0 |
| # of traffic flow interruptions (ramps, intersections, entrance and exists | 0.1 | 0.5 | 0.0 | 6.0 |
| Averaged daily VMT (veh.mi/day) | 3034.9 | 5525.3 | 3.5 | 80258.0 |
| Averaged daily VMT in adverse weather (veh.mi/day) | 130.5 | 247.8 | 0.1 | 4028.2 |
| Averaged daily VMT in clear weather (veh.mi/day) | 2904.4 | 5279.7 | 3.4 | 76229.8 |
| Segment length (mile) | 0.1 | 0.1 | 0.0 | 07 |
| # of crashes in 2017 (adverse weather) | 0.3 | 1.0 | 0.0 | 32.0 |
| # of crashes in 2016 (adverse weather) | 0.3 | 1.1 | 0.0 | 26.0 |
| # of crashes in 2015 (adverse weather) | 0.3 | 1.0 | 0.0 | 18.0 |
| # of crashes in 2017 (clear weather) | 2.2 | 5.6 | 0.0 | 105.0 |
| # of crashes in 2016 (clear weather) | 2.3 | 5.7 | 0.0 | 95.0 |
| # of crashes in 2015 (clear weather) | 1.9 | 4.6 | 0.0 | 64.0 |

TABLE 2

Distribution of the categorical variables

| Curve flag | | | Median flag | | |
|---|---|---|---|---|---|
| Level | Frequency | Percentage | Level | Frequency | Percentage |
| No | 23572 | 80.23 | No | 15127 | 51.48 |
| Yes | 5810 | 19.77 | Yes | 14255 | 48.52 |
| Number of lanes | | | Inner side paved shoulder flag | | |
| Level | Frequency | Percentage | Level | Frequency | Percentage |
| 2 | 9307 | 31.68 | No | 7004 | 23.84 |
| 3 | 212 | 0.72 | Yes | 22378 | 76.16 |
| 4 | 12907 | 43.93 | Outer side paved shoulder flag | | |
| 5 | 338 | 1.15 | Level | Frequency | Percentage |
| 6 | 4809 | 16.37 | No | 5548 | 18.88 |
| 7 | 124 | 0.42 | Yes | 23834 | 81.12 |
| 8 | 1215 | 4.14 | Speed limit | | |
| 9 | 75 | 0.26 | Level | Frequency | Percentage |
| 10 | 335 | 1.14 | 20-35 | 1359 | 4.63 |
| 11 | 21 | 0.07 | 36-50 | 6012 | 20.46 |
| 12 | 36 | 0.12 | 51-60 | 11321 | 38.53 |
| 13 | 3 | 0.01 | 61-70 | 7808 | 26.57 |
| | | | 71-85 | 2882 | 9.81 |

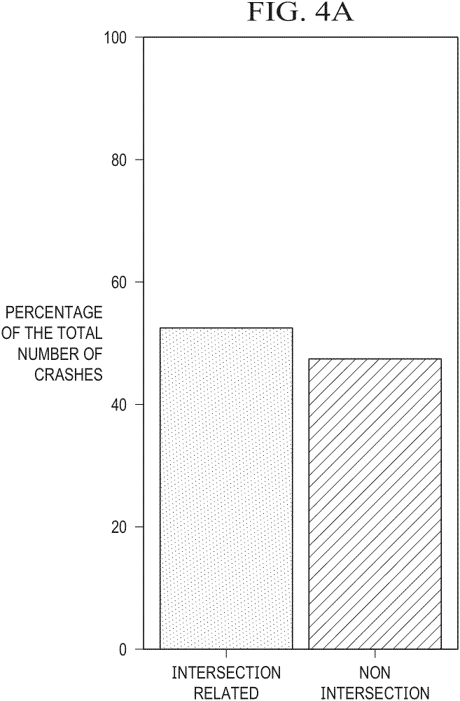

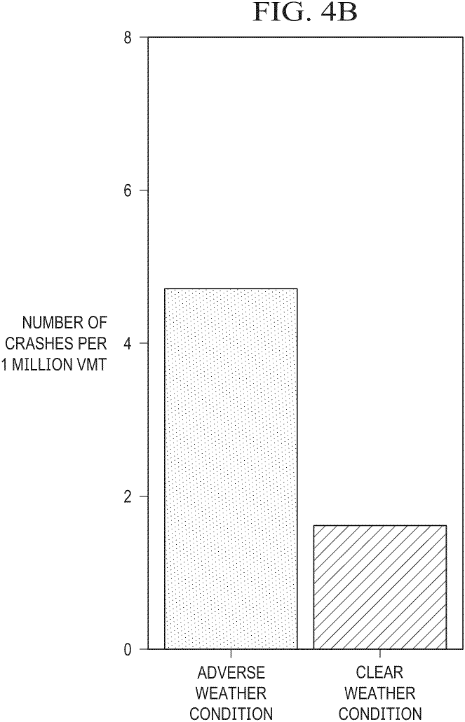

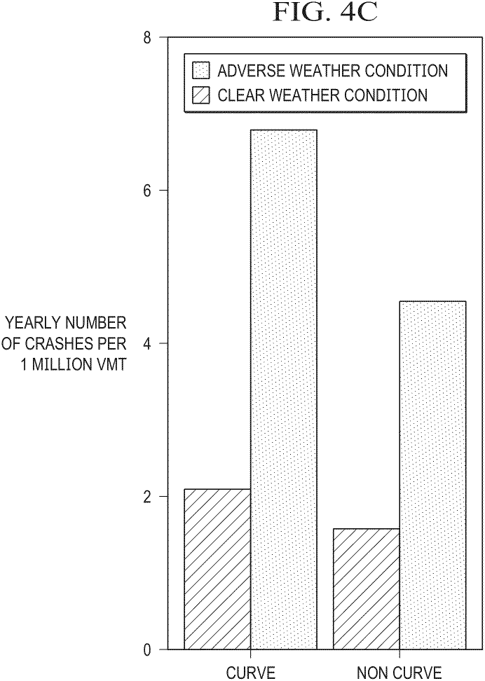

Two separate datasets, for adverse and clear weather conditions, were built. Explanatory analyses of crash data from 2015 to 2017 showed the role of adverse weather conditions in increasing the rate of crashes. FIGS. 4A-4C are graphs illustrating explanatory analyses of crash data from and showing the role of adverse weather conditions in increasing the rate of crashes according to aspects of the disclosure. In the studied area, the average yearly rate of crashes in terms of the number of crashes per 1-million vehicle-mile travelled in adverse weather conditions was observed 2.7 times higher than the rate of crashes in clear weather. About 53% of crashes were related to intersections, which implies a higher risk of crash occurrence at the intersection, with more traffic conflicts. The roadway curvature is detected as a potential hotspot for crashes where the rate of crashes is higher in road curves. A more significant impact of road curvature on crash rates was observed in the adverse weather condition with a 30% higher rate of crashes at road segments located in curves comparing to others.

### Step II: Crash Prediction Models

Crashes are rare events and are often associated with several factors beyond driver-vehicle variables, such as road, traffic, and weather conditions. Given that, roadway safety was evaluated using the expected value of crashes rather than the historical crash frequency. It has been shown that crashes are independent events with an unequal probability of occurrence, which can be approximated with the Negative Binomial (NB) distribution. The NB distribution can also handle the over-dispersion in the data, which is ubiquitous in crash data. To this end, NB regression is utilized to estimate the expected value of crashes. The significant differences in crash rates in adverse and clear weather conditions resulted in development of separate models for each weather condition. Crash-frequency prediction model 112 is discussed below.

The goodness-of-fit (GOF) of the models was compared using the log-likelihood of the fitted model and the Akaike information criterion (AIC). The AIC was estimated using Equation 1:

$$A I C = - 2 \left(log - l i k l i h o o d\right) + 2 K \qquad \text{Equation 1:}$$

Where K is the number of model parameters.

The prediction power of the model was also evaluated in terms of Mean Absolute Error (MAE) and Root Square Mean Errors (RSME) (Equation 2 and 3).

$$M A E = \frac{1}{n} {\sum }_{i = 1}^{n} \left|{y}_{i} - \hat{{y}_{i}}\right| \qquad \text{Equation 2:}$$

$$R S M E = \sqrt{\frac{1}{n} {\sum }_{i = 1}^{n} {\left({y}_{i} - \hat{{y}_{i}}\right)}^{2}} \qquad \text{Equation 3:}$$

where n, yᵢ and ŷᵢ represent the sample size, observed number of crashes, and predicted number of crashes at road segment i, respectively.

### Step III: Crash Risk Estimation

Risk analysis 116 is estimated using the theoretical probability of the complement of observing zero crashes, i.e., survival. As opposed to experimental probability, which can be estimated as a ratio of the expected number of crashes and VMT, the theoretical probability of crashes was used given that this analysis is ran using the data from a limited time (three years). Although theoretical and experimental probabilities can be inconsistent for three years, it is expected that the experimental probability converges to the theoretical probability in a longer period of time. Since it was assumed that the crash data could be drawn from NB distribution, the theoretical probability (hereafter, probability) of survival in a year at the road segment i can be calculated by the NB probability density function (Equation 4).

$$P \left(y = {y}_{i} \left|{μ}_{i} , α\right)\right) = \frac{\text{Γ} \left({y}_{i} + {α}^{- 1}\right)}{\text{Γ} \left({y}_{i} + 1\right) \text{Γ} \left({α}^{- 1}\right)} {\left(\frac{{α}^{- 1}}{{α}^{- 1} + {μ}_{i}}\right)}^{{α}^{- 1}} {\left(\frac{{μ}_{i}}{{α}^{- 1} + {μ}_{i}}\right)}^{{y}_{i}} \qquad \text{Equation 4:}$$

where µ and a are the mean (i.e., expected value) and the dispersion parameter, respectively. In the NB regression, the expected value of y at the road segment i (µi) is determined by a set of k regressors (x):

$${μ}_{i} = V M {T}_{i} \times e x p \left({β}_{0} + {β}_{1} {x}_{1 i} + {β}_{2} {x}_{2 i} + ⋯ + {β}_{k} {x}_{k i}\right) \qquad \text{Equation 5:}$$

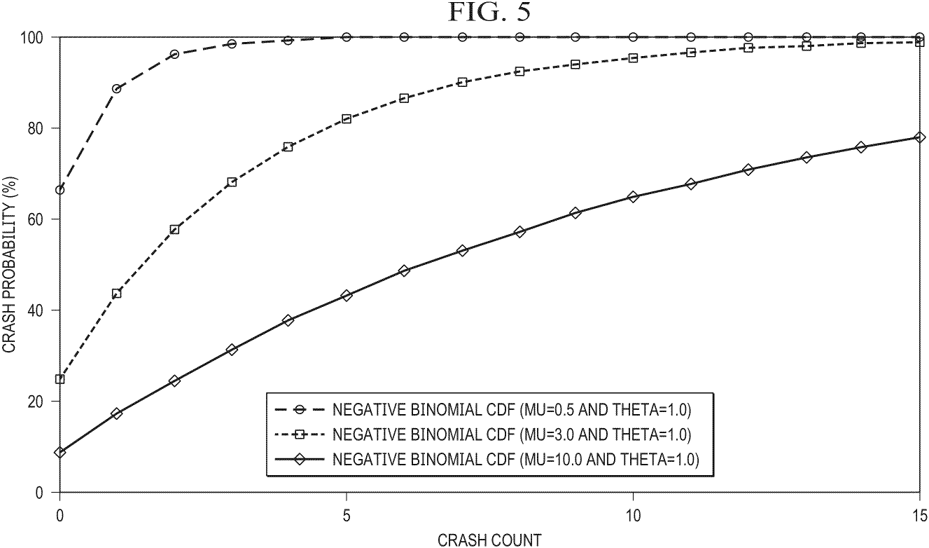

Using the NB regression estimates and Equations 4 and 5, the probability of observing zero-crashes in a year can be estimated for road segment i. For the sake of further clarification, three arbitrary NB cumulative distribution functions (CDF) are demonstrated in FIG. 5. The probability of observing zero crashes in a year at road segment i where the expected value and the dispersion parameter have been estimated as 3.0 and 1.0, respectively, is equal to 0.66.

The yearly probability of survival in a route can be further estimated by multiplying the survival probability of each road segment. The survival probability at n road segments of route k can be determined using Equation 6.

$${S}_{k} = {S}_{k , 1} ∩ {S}_{k , 2} ∩ … ∩ {S}_{k , n} = {\prod }_{1}^{n} {S}_{k , i} \qquad \text{Equation 6:}$$

Respectively, the yearly probability of observing at least one crash in a route can be estimated as the complement of the survival probability, P(at least one crash at a road segment)=1-Sₖ . Given the small values of yearly survival probability in a route and to have a more tangible presentation of the results, the yearly survival probability at a road segment was converted to daily probabilities assuming the equal daily probability of crashes across a year. This assumption is in agreement with the common usage of ADT in the crash frequency models, assuming a uniform distribution of yearly traffic across days.

### Step IV: Comparing the Shortest and Safest Route

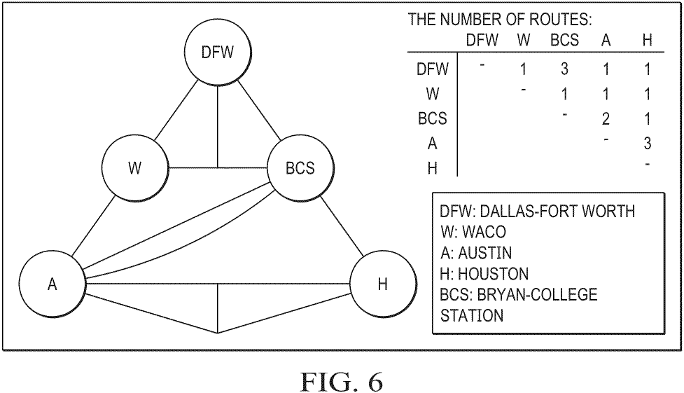

The alternative routes between pairs of origin and destination were identified considering two criteria. First, routes with up to 20% higher travel time than the shortest route between origins and destinations were included. The travel time is estimated for free-flow traffic conditions. Second, the routes consisting of the road functional classification higher than arterials, interstate, freeway/expressways, and arterials are selected. Estimate 118 is data regarding an estimation of the travel time for each rout. FIG. 6 is a schematic illustrating alternative routes. In this step of the analysis, for each pair of origin and destination, the travel time and the daily probability of crashes in the route alternatives was compared.

### Crash Prediction Model Estimation Results

The dataset was divided into two subsets, testing and training datasets. The training dataset used for developing models and the models’ prediction power was examined using the testing dataset. The models were developed to predict the number of crashes in 2017 at the road segment level.

The estimated models for adverse weather and clear weather conditions are reported in Table 3. All of the model coefficients were significant, with a 95% confidence interval. As discussed before, the length of the road segment and the ADT were considered as exposure variables. The average of the observed number of crashes in the previous two years was included as an independent variable in the model. This variable can account for unobserved factors that may affect the risk of crashes. A higher number of crashes is expected in adverse weather conditions at urban roads. For an additional traffic interruption (ramp, intersection, exist, and entrance) in the road segment, 22% and 14% more crashes are expected in adverse weather conditions and clear weather conditions, respectively. The existence of the median and paved outer shoulders will reduce the likelihood of crashes in clear weather conditions. A higher number of crashes is expected in road segments located in a road segment with higher curvature.

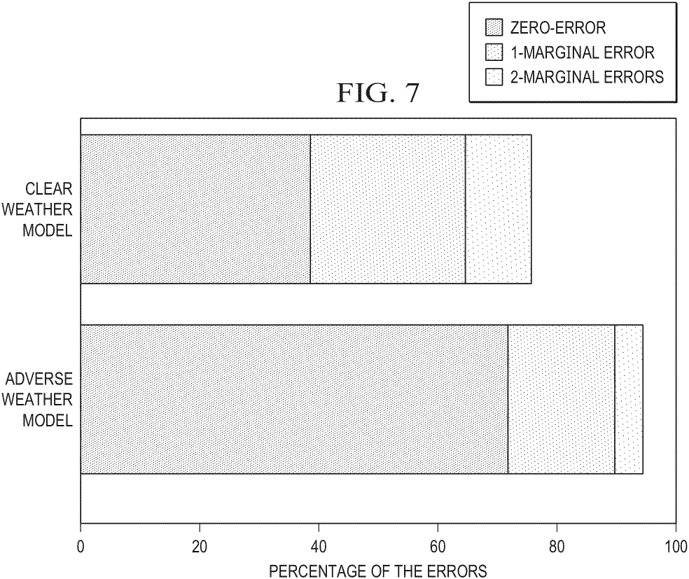

The GOF of the models indicates that the model for adverse weather conditions is a better fit to the observed number of crashes in 2017 comparing to the model for clear weather condition. For evaluating the prediction power of the model, a random number was drawn from NB distribution with the estimated expected value and dispersion for each road segment. The MAE of the models for adverse and clear weather conditions is estimated at 0.739 and 5.899, respectively. A closer look at the distribution of the absolute prediction errors indicated that the likelihood of predicting the number of crashes with two marginal error at the road segment level is equal to 94% for the adverse weather model and 73% for the clear weather model (FIG. 7).

TABLE 3

Estimated models

| Variables | Estimated Model | | | | | |
|---|---|---|---|---|---|---|
| | Adverse weather condition | | | Clear weather condition | | |
| | Coefficient | SE | z value | Coefficient | SE | z value |
| Constant | -3.802 | 0.037 | -102.345* | -2.448 | 0.017 | -144.708* |
| log (averaged number of crashes in previous two years+1) | 1.411 | 0.017 | 82.397* | 1.090 | 0.005 | 222.214* |
| Urban roads (1 if yes, 0 otherwise) | 0.439 | 0.035 | 12.610* | - | - | - |
| # of traffic flow interruptions in the segment | 0.222 | 0.017 | 13.192* | 0.139 | 0.009 | 15.768* |
| Paved outside shoulder (1 if the outside shoulder is paved, 0 otherwise) | - | - | - | -0.065 | 0.016 | -3.950* |
| 1/Radius of the curves | 1.219 | 0.265 | 4.600* | 0.499 | 0.154 | 3.234* |
| NB Dispersion parameter | 0.455 | 0.114 | 3.994* | 0.229 | 0.142 | 1.617** |
| Goodness of fit | | | | | | |
| 2*loglikelihood | -25,421.112.00 | | | -62,211.218.00 | | |
| AIC | 25,833 | | | 62,223 | | |
| Prediction power | | | | | | |
| MAE | | 0.739 | | | 5.899 | |
| RSME | | 3.157 | | | 44.542 | |

*significant with a 95% confidence interval
**significant with a 90% confidence interval

### Comparison Between the Shortest and the Safest Route

Safety analysis 120 considers the cumulative risk of crashes and the travel time in the free-flow conditions, which are compared in Table 4. The results unveiled inconsistency in the shortest and safest routes between origins and destinations. Taking the shortest route instead of the safest route, for example, between DFW and BCS will reduce the travel time by 8%; however, the daily probability of crashes in adverse weather conditions will be increased by 23% compared to the safest route. This comparison indicates that the safest routes between a pair of origin and destination can vary in different weather conditions. In clear weather conditions, taking the shortest route between, for example, DFW and BCS will result in an 8% decrease in travel time and a 20% increase in crash risk. Taking a route between, for example, Austin and BCS with 1% lower travel time will result in a 6% higher risk of crashes in a clear weather condition. In contrast, the safest route is the same as the shortest route between, for example, Austin and BCS in adverse weather conditions. Analysis suggests that taking the longest route between, for example, Austin and Houston with 11% higher travel time will result in a 1% decrease in the daily probability of crashes.

TABLE 4

Comparing travel time and cumulative risk of crashes

| Origin-destination | Routes | Length (mile) | Travel time (minute) | Deviation from the shortest route | Adverse weather condition | | Clear weather condition | |
|---|---|---|---|---|---|---|---|---|
| | | | | | Daily risk of crashes (%) | Deviation from the safest route (%) | Daily risk of crashes (%) | Deviation from the safest route (%) |
| DFW- | DB1 | 166 | 160 | 0% | 71% | 20% | 54% | 23% |
| Bryan | DB2 | 171 | 165 | 3% | 73% | 24% | 53% | 20% |
| | DB3 | 175 | 172 | 8% | 59% | 0% | 44% | 0% |
| BCS- | BA1 | 107 | 112 | 0% | 79% | 0% | 64% | 6% |
| Austin | BA2 | 108 | 113 | 1% | 81% | 3% | 60% | 0% |
| Houston- | HA1 | 162 | 154 | 0% | 57% | 0% | 41% | 1% |
| Austin | HA2 | 165 | 157 | 2% | 61% | 6% | 41% | 4% |
| | HA3 | 171 | 171 | 11% | 59% | 4% | 40% | 0% |

### S-RGS Route Finding

The result of the comparison between the shortest and safest routes between, for example, five Texas metropolitan areas indicated the need for considering traffic safety in the RGS. In this section, the variation of RGS algorithms is discussed, and propose a route-finding architecture for S-RGS that seeks the safest route is proposed according to various embodiments.

### RGS Algorithm Classification

Depending on whether or not the RGS reacts to up-to-date information about road and traffic conditions, the route-finding algorithm can be divided into two types: static and dynamic. Specifically, dynamic RGS takes into account real-time data on traffic, road closures, and incidents. In addition, RGSs can be classified according to the reactive or predictive nature of the algorithm. Reactive route guidance is based solely on the current conditions of the travel network, without insight into future conditions; predictive routing systems, on the other hand, are based on anticipated road conditions resulting from an iterative prediction algorithm. RGSs are also distinguished according to the definition of their ultimate goal: a centralized system aims to maximize benefits for the road network, while a decentralized system aims to optimize benefits for the individual user.

The level of complexity and reliability of RGSs varies according to the algorithm classifications mentioned above. For example, while dynamic route finding is a more complex algorithm with a higher level of reliability compared to static route finding, predictive RGS can give insight into the future condition of a road network and provide users with more reliable guidance, but with the cost of extensive prediction modeling. With regard to commercialized road navigation systems, these are mainly designed to maximize benefits for the user (i.e., minimizing travel time), not for the road transport system.

In the context of route-finding based on safety, S-RGSs can be designed as static or dynamic systems. Since the goal of finding the safest route is to prevent crashes, the S-RGS needs to predict the risk of crashes in the future, and so a reactive algorithm would not be effective. Also, guiding users to a road that carries a higher risk of crashes in order to prevent more crashes would be morally unjustifiable. Therefore, the S-RGS needs to perform as a decentralized system to avoid such an ethical controversy.

### The Safest Route-finding Architecture

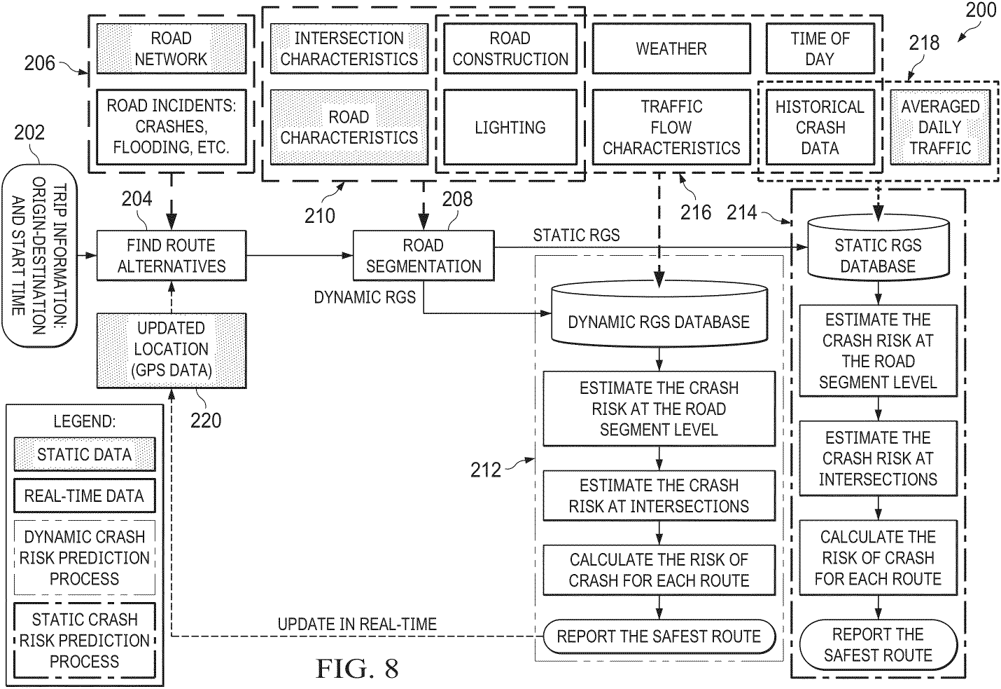

FIG. 8 is a flow diagram illustrating a method 200 of route-finding according to aspects of the disclosure. FIG. 8 illustrates a proposed static and dynamic S-RGS architecture. Method 200 may be implemented using, for example, the S-RGS 300 of FIG. 9. At step 202, S-RGS 300 receives trip information—i.e., the origin and destination of a trip in a given time of day. At step 204 route alternatives are identified utilizing data 206 that includes road network data and possible incidents - e.g., road or lane closures due to flooding, and accident(s).

At step 208, for the sake of crash risk predictions, the road network is divided into homogeneous road segments with similar road characteristics from data 210. Data 210 includes, for example, road characteristics (e.g., road curvature, shoulder type and width, median type and width, pavement, traffic disruption (entrance, exit, and intersection), functional classification, number of lanes, and lane width). Similarly, intersections and their characteristics (number of approaches, geometry design, and control) are identified. In the dynamic system, data 216 may also be considered and includes illumination condition, road closure, and road construction should be used for route identification and road segmentation. Data 218 includes historical crash data and traffic information. Data 218 is assigned to the road segments of each route and are stored in the system as the crash risk prediction database.

For dynamic route guidance, method 200 proceeds to step 212. Dynamic route guidance is available, for example, depending on the capabilities of a user’s S-RGS. For dynamic route guidance, the S-RGS iteratively checks for new information while route guidance is displayed to a user. For example, the S-RGS may have a wireless data connection that allows the S-RGS to receive up to date information regarding traffic, weather, crash information, etc. In some aspects, a user’s S-RGS is configured for static route guidance. For static route guidance, method 200 proceeds to route 214. For static route guidance, the S-RGS relies upon previously collected information. Though static, this information may be periodically updated via software updates (e.g., downloaded while the S-RGS has access to the Internet at home, work, etc.).

At step 212, data for dynamic S-RGS is collected in a dynamic RGS database that incorporates data from step 208 and data 216 and includes real-time traffic data, such as traffic flow and speed, need to be collected in addition to information about weather conditions (e.g., precipitation, wind speed, and visibility), time of day (peak/off-peak), lighting, and potential work construction at the time of the trip. Step 212 also includes an estimation of crash risk for each road segment and each intersection. The estimated crash risks are used to calculate the risk for each route. The safest route is identified as the route with the lowest estimated overall crash risk and is reported back to the S-RGS for display to a user. Steps 204, 208, 212 are iterated for dynamic updates to update the route guidance in real-time and to inform the user about the potential alternative safest route.

At step 214, data for static S-RGS is collected in a static RGS database that incorporates data from step 208 and data 218. In contrast to dynamic route guidance, static route guidance does not include real-time traffic data. Step 214 also includes an estimation of crash risk for each road segment and each intersection. The estimated crash risks are used to calculate the risk for each route. The safest route is identified as the route with the lowest estimated overall crash risk and is reported back to the S-RGS for display to a user.

Since the basis of the analysis is at the road segment level, homogeneous road segments in terms of geometry, cross-section characteristics, and illumination are defined. In various aspects, the Road Curvature Analyst (ROCA) tool is used for extracting the road curvatures and its characteristics. This geographical information system (GIS) based tool identifies the horizontal curves and tangents using machine learning techniques and computes the horizontal curve radii and the azimuth of tangents. In various embodiments, roads were divided into segments with homogeneous characteristics, including road alignment, number of lanes, median type and width, shoulders type and width, lighting, and lane width.

The risk of crashes at the road segments and intersections is predicted and accumulated for each route. For the static S-RGS, different variations of the prediction models can be used. For estimating the risk of crashes in a dynamic RGS, real-time crash prediction models (RTCPM) need to be employed to predict the risk of crashes in the short-term. In various embodiments, RTCPMs employ machine learning techniques to predict the risk of crashes in real-time based on road characteristics as well as real-time traffic and weather conditions.

### Requirement for and Barriers to Implementing S-RGS

While S-RGSs have promising safety impacts, their implementation is heavily dependent on the availability of data, crash risk prediction precision, and the optimum pathfinding algorithm. The required data for a static S-RGS are limited to road network data— road and intersection characteristics, averaged traffic flow, and historical crashes—that are expected to be available to local or federal government agencies responsible for road transportation. In contrast to static S-RGS, a dynamic S-RGS is developed based on real-time data—including real-time incidents, road construction, illumination, weather condition, and traffic flow characteristics, of which incident and traffic data are more challenging to gather than the others. Collecting traffic flow and incident data requires extensive equipment (e.g., loop detectors, cameras); however, approximations from crowd-sourced data can be an alternative. Google Maps and Waze are two examples of the commonly used RGSs (in the form of smartphone apps) that are benefiting from the data so extracted from users.

As previously demonstrated, the shortest path is not necessarily the safest one. Given the fact that crashes can affect not only those directly involved but also other road users, leaving the choice between safety and time to the users may result in unethical decisions and unfair consequences. For example, drivers with a lower sensitivity to safety may take the route with a higher risk of crashes in order to reduce their travel time. In the case of being involved in a crash, all road users will be affected by this decision. Therefore, the trade-off between safety and travel time needs to be addressed in the S-RGS algorithm.

The comparison between the shortest and safest routes between, for example, five metropolitan areas in Texas revealed the potential of commonly used road navigation apps to misguide users toward using a road that carries a higher risk of crashes. It was shown that reducing travel time by 8% can result in a 23% higher risk of involvement in crashes. Our analysis also suggests that the safest route between a pair origin and destination points can vary depending on weather conditions. These observations indicated the necessity of considering safety in RGSs.

In various embodiments, a system architecture was proposed for the safest route finding of S-RGSs. In various embodiments, the safest route finding may be solved with a decentralized system. Also, given that the S-RGS aims to prevent crashes, predictive algorithms are required to find the safest route. S-RGSs can perform as static or dynamic systems; while static systems are less complex than dynamic ones, this comes at the cost of greater vulnerability to temporal changes, including traffic flow fluctuations, illumination, weather conditions, work zones, and incidents. In various embodiments, the requirements of deploying S-RGSs are (1) real-time traffic flow and incident information for dynamic S-RGS, (2) accurate crash prediction models, and (3) acknowledging the trade-off between travel time and safety in order to find the optimal route.

In various embodiments, the shortest and safest routes between a set of origins and destinations were compared after proposing a new method for estimating the risk of crashes. Publicly available data were used for this analysis. In various embodiments, a system to enable drivers to find the safest route is described. In various embodiments, the proposed static safest route-finding architecture was designed to use publicly available datasets, and therefore to be simple to implement.

FIG. 9 illustrates an example of an S-RGS 300 that, in some cases, can be representative, for example, of S-RGS’s and various computer systems for determining and displaying safe route guidance. S-RGS 300 includes an application 314 operable to execute on computer resources 302. Application 314 can be, for example, an interface for operating S-RGS 300. In other embodiments, application 314 can be, for example, an interface for operating and/or accessing all engines and datastores of S-RGS 300. In particular embodiments, S-RGS 300 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of S-RGS 300 may comprise any suitable physical form, configuration, number, type and/or layout. As an example, and not by way of limitation, S-RGS 300 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, S-RGS 300 may include one or more computer systems; be unitary or distributed; span multiple locations; span multiple machines; or reside in a cloud, which may include one or more cloud components in one or more networks.

In the depicted embodiment, S-RGS 300 includes a processor 308, memory 312, storage 310, a display 316, interface 306, and bus 304. Although a particular computer system is depicted having a particular number of particular components in a particular arrangement, this disclosure contemplates any suitable computer system having any suitable number of any suitable components in any suitable arrangement.

Processor 308 may be a microprocessor, controller, or any other suitable computing device, resource, or combination of hardware, software and/or encoded logic operable to execute, either alone or in conjunction with other components, (e.g., memory 312), the application 314. Such functionality may include providing various features discussed herein. In particular embodiments, processor 308 may include hardware for executing instructions, such as those making up the application 314. As an example, and not by way of limitation, to execute instructions, processor 308 may retrieve (or fetch) instructions from an internal register, an internal cache, memory 312, or storage 310; decode and execute them; and then write one or more results to an internal register, an internal cache, memory 312, or storage 310. Display 316 is configured to display information to a user (e.g., route guidance information). In some aspects, display 316 may be a touchscreen display that receives input from a user (e.g., origin and our destination information). In some aspects, display 316 may be integrated into S-RGS 300 (i.e., when S-RGS 300 is a mobile, stand-alone unit). In some aspects, display 316 may be integrated into a vehicle (i.e., a part of the infotainment and/or navigation system of an automobile in which S-RGS 300 is installed).

In particular embodiments, processor 308 may include one or more internal caches for data, instructions, or addresses. This disclosure contemplates processor 308 including any suitable number of any suitable internal caches, where appropriate. As an example, and not by way of limitation, processor 308 may include one or more instruction caches, one or more data caches, and one or more translation lookaside buffers (TLBs). Instructions in the instruction caches may be copies of instructions in memory 312 or storage 310 and the instruction caches may speed up retrieval of those instructions by processor 308. Data in the data caches may be copies of data in memory 312 or storage 310 for instructions executing at processor 308 to operate on; the results of previous instructions executed at processor 308 for access by subsequent instructions executing at processor 308, or for writing to memory 312, or storage 310; or other suitable data. The data caches may speed up read or write operations by processor 308. The TLBs may speed up virtual-address translations for processor 308. In particular embodiments, processor 308 may include one or more internal registers for data, instructions, or addresses. Depending on the embodiment, processor 308 may include any suitable number of any suitable internal registers, where appropriate. Where appropriate, processor 308 may include one or more arithmetic logic units (ALUs); be a multi-core processor; include one or more processors 308; or any other suitable processor.

Memory 312 may be any form of volatile or non-volatile memory including, without limitation, magnetic media, optical media, random access memory (RAM), read-only memory (ROM), flash memory, removable media, or any other suitable local or remote memory component or components. In particular embodiments, memory 312 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 312 may include one or more memories 312, where appropriate. Memory 312 may store any suitable data or information utilized by S-RGS 300, including software embedded in a computer readable medium, and/or encoded logic incorporated in hardware or otherwise stored (e.g., firmware). In particular embodiments, memory 312 may include main memory for storing instructions for processor 308 to execute or data for processor 308 to operate on. In particular embodiments, one or more memory management units (MMUs) may reside between processor 308 and memory 312 and facilitate accesses to memory 312 requested by processor 308.

As an example, and not by way of limitation, S-RGS 300 may load instructions from storage 310 or another source (such as, for example, another computer system) to memory 312. Processor 308 may then load the instructions from memory 312 to an internal register or internal cache. To execute the instructions, processor 308 may retrieve the instructions from the internal register or internal cache and decode them. During or after execution of the instructions, processor 308 may write one or more results (which may be intermediate or final results) to the internal register or internal cache. Processor 308 may then write one or more of those results to memory 312. In particular embodiments, processor 308 may execute only instructions in one or more internal registers or internal caches or in memory 312 (as opposed to storage 310 or elsewhere) and may operate only on data in one or more internal registers or internal caches or in memory 312 (as opposed to storage 310 or elsewhere).

In particular embodiments, storage 310 may include mass storage for data or instructions. As an example, and not by way of limitation, storage 310 may include a hard disk drive (HDD), a floppy disk drive, flash memory, an optical disc, a magneto-optical disc, magnetic tape, or a Universal Serial Bus (USB) drive or a combination of two or more of these. Storage 310 may include removable or non-removable (or fixed) media, where appropriate. Storage 310 may be internal or external to S-RGS 300, where appropriate. In particular embodiments, storage 310 may be non-volatile, solid-state memory. In particular embodiments, storage 310 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 310 may take any suitable physical form and may comprise any suitable number or type of storage. Storage 310 may include one or more storage control units facilitating communication between processor 308 and storage 310, where appropriate.

In particular embodiments, interface 306 may include hardware, encoded software, or both providing one or more interfaces for communication (such as, for example, packet-based communication) among any networks, any network devices, and/or any other computer systems. As an example, and not by way of limitation, communication interface 306 may include a network interface controller (NIC) or network adapter for communicating with an Ethernet or other wire-based network and/or a wireless NIC (WNIC) or wireless adapter for communicating with a wireless network.

Depending on the embodiment, interface 306 may be any type of interface suitable for any type of network for which S-RGS 300 is used. As an example, and not by way of limitation, S-RGS 300 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, S-RGS 300 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. S-RGS 300 may include any suitable interface 306 for any one or more of these networks, where appropriate.

In some embodiments, interface 306 may include one or more interfaces for one or more I/O devices. One or more of these I/O devices may enable communication between a person and S-RGS 300. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 306 for them. Where appropriate, interface 306 may include one or more drivers enabling processor 308 to drive one or more of these I/O devices. Interface 306 may include one or more interfaces 306, where appropriate.

Bus 304 may include any combination of hardware, software embedded in a computer readable medium, and/or encoded logic incorporated in hardware or otherwise stored (e.g., firmware) to couple components of S-RGS 300 to each other. As an example and not by way of limitation, bus 304 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 304 may include any number, type, and/or configuration of buses 304, where appropriate. In particular embodiments, one or more buses 304 (which may each include an address bus and a data bus) may couple processor 308 to memory 312. Bus 304 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 308 (such as, for example, one or more internal registers or caches), one or more portions of memory 312, one or more portions of storage 310, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially,” “approximately,” “generally,” and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an,” and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A route guidance system for determining a safe route, the route guidance system comprising a processor and memory operable for carrying out a method comprising:
receiving trip information from a user, the trip information comprising an origin and a destination;
identifying route alternatives for routes between the origin and the destination;
for each route alternative dividing a road network into a plurality of homogenous road segments;
assigning crash data to each road segment of the plurality of homogeneous road segments;
accumulating crash risk for each route of the route alternatives; and
determining which route of the route alternatives has a lowest crash risk.

2. The route guidance system of claim 1, wherein accumulating crash risk comprises analyzing real-time traffic data.

3. The route guidance system of claim 2, wherein the real-time traffic data includes at least one of traffic flow, traffic speed, precipitation, wind speed, visibility, time of day, lighting, and presence of road construction.

4. The route guidance system of claim 1, wherein the reporting is iterative based on changes in real-time traffic information.

5. The route guidance system of claim 1, wherein the assigning crash data includes an assessment of road characteristics including at least one of road curvature, shoulder type and width, median type and width, pavement, traffic disruption, functional classification, number of lanes, and lane width.

6. The route guidance system of claim 5, wherein a road curvature analyst tool is used to determine the road characteristics.

7. The route guidance system of claim 1, wherein identifying route alternatives includes monitoring at least one of road incidents, crashes, and flooding.

8. The route guidance system of claim 1, wherein the dividing the road network is based upon at least one of intersection characteristics, road characteristics, road construction, and lighting.

9. The route guidance system of claim 1, wherein the method further comprises displaying the route with the lowest crash risk on a display of the route guidance system.

10. The route guidance system of claim 1, wherein the method further comprises displaying the route with the lowest crash risk on a display associated with a vehicle in which the route guidance system is installed.

11. A computer-program product comprising a non-transitory computer-usable medium having computer-readable program code embodied therein, the computer-readable program code adapted to be executed to implement a method comprising:
receiving trip information from a user, the trip information comprising an origin and a destination;
identifying route alternatives for routes between the origin and the destination;
for each route alternative, dividing a road network into a plurality of homogenous road segments;
assigning crash data to each road segment of the plurality of homogeneous road segments;
accumulating crash risk for each route of the route alternatives; and
determining which route of the route alternatives has a lowest crash risk.

12. The method of claim 11, wherein accumulating crash risk comprises analyzing real-time traffic data.

13. The method of claim 12, wherein the real-time traffic data includes at least one of traffic flow, traffic speed, precipitation, wind speed, visibility, time of day, lighting, and presence of road construction.

14. The method of claim 11, wherein the reporting is iterative based on changes in real-time traffic information.

15. The method of claim 11, wherein the homogeneous road segments are determined based on road characteristics, including road curvature, shoulder type and width, median type and width, pavement, traffic disruption, functional classification, number of lanes, and lane width.

16. The method of claim 15, wherein a road curvature analyst tool is used to determine the road characteristics.

17. The method of claim 11, wherein identifying route alternatives includes monitoring at least one of road incidents, crashes, and flooding.

18. The method of claim 11, wherein the dividing the road network is based upon at least one of intersection characteristics, road characteristics, road construction, and lighting.

19. The method of claim 11, wherein the method further comprises displaying the route with the lowest crash risk on a display of the route guidance system.

20. The route guidance system of claim 11, wherein the method further comprises displaying the route with the lowest crash risk on a display associated with a vehicle in which the route guidance system is installed.
